(19) United States
(12) Patent Application Publication
(10) Pub. No.: US 2026/0223241 A1
(43) Pub. Date: Jul. 30, 2026

(54) CELL DTX AND UE DRX ALIGNMENT

(71) Applicant: Lenovo (Beijing) Limited, Beijing (CN)

(72) Inventors: Zhi Yan, Beijing (CN); Hongmei Liu, Beijing (CN); Yuantao Zhang, Beijing (CN); Ruixiang Ma, Beijing (CN); Yingying Li, Beijing (CN); Haiming Wang, Beijing (CN)

(73) Assignee: Lenovo (Beijing) Limited, Beijing (CN)

(21) Appl. No.: 19/142,121

(22) PCT Filed: Dec. 30, 2022
(86) PCT No.: PCT/CN2022/143906

§ 371 Date: Jun. 20, 2025

(51) Int. Cl. H04W 76/28

(52) U.S. Cl. CPC H04W 76/28

(57) ABSTRACT

Methods and apparatuses for cell DTX and UE DRX alignment are disclosed. A UE comprises a processor; and a transceiver coupled to the processor, wherein the processor is configured to receive, via the transceiver, a UE DRX configuration, and a cell DTX configuration; and determine new UE DRX parameters according to the UE DRX configuration and the cell DTX configuration.

### FIELD

The subject matter disclosed herein generally relates to wireless communications, and more particularly relates to methods and apparatuses for cell DTX and UE DRX alignment.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Discontinuous Reception (DRX), Connected Discontinuous Reception (C-DRX), Downlink Control Information (DCI), Physical Downlink Control Channel (PDCCH), discontinuous transmission (DTX), system frame number (SFN).

To prolong UE battery lifetime, Discontinuous Reception (DRX) mechanism was introduced in the early stage of LTE and inherited by NR. DRX mechanism is beneficial for lowering UE power consumption by allowing UE to enter power saving mode periodically.

FIG. 1 illustrates a principle of DRX mechanism. A DRX cycle can be composed of DRX active time period, in which UE is active to monitor control signal, and DRX off period, in which UE is inactive and UE doesn't need to monitor any control signal. During the DRX OnDuration period, if a DCI indicating a new UL or DL transmission is received on PDCCH, a DRX inactivity timer is started or restarted in the first symbol after the end of the PDCCH reception. The UE is active to monitor control signal until the DRX inactivity timer expires, at which the DRX active time period ends. If no DCI is received during the DRX OnDuration period, the UE enters into DRX off period after the DRX OnDuration period.

FIG. 2 illustrates a principle of Connected Discontinuous Reception (C-DRX), in which short DRX cycle and long DRX cycle are provided. The long DRX cycle corresponds to the DRX cycle in FIG. 1, while the short DRX cycle is optionally configured. The short DRX cycle is configured to avoid immediate action for large sleeping mode of long DRX Cycle.

In FIG. 2, there is an offset (e.g., drx-StartOffset +drx-SlotOffset) from the start of the long DRX cycle to the start of the UE DRX OnDuration period. The offset is 1 (e.g., 1 ms) in FIG. 2, which implies that drx-StartOffset=1 ms while drx-SlotOffset=0. In FIG. 2, the long DRX cycle (e.g., drx-LongCycle) is 80 ms, the short DRX cycle (e.g., drx-ShortCycle) is 20 ms, and the occasions of short DRX cycle (e.g., drx-ShortCycleTimer) is 2 (i.e., there are 2 short DRX cycles). Incidentally, the long DRX cycle shall be configured as multiple times of the short DRX cycle (e.g., 80 ms=4*20 ms). The following steps i) to v) are included:
i) C-DRX is configured and the last DCI (PDCCH) arrived.
ii) DRX inactivity timer (e.g., drx-inactivityTimer) starts (e.g., a DCI is received on PDCCH during the DRX OnDuration period) and ‘Wake-up status’ (e.g., DRX active time period) continues until the DRX inactivity timer (e.g., drx-inactivityTimer) expires.
iii) After the DRX inactivity timer (e.g., drx-inactivityTimer) expired and the short DRX cycle (e.g., shortDrxCycle) condition is met, the short DRX cycle (e.g., shortDrxCycle) starts and the DRX short cycle timer (e.g., drxShortCycleTimer) starts.
iv) If there is no DCI (no PDCCH) until the DRX short cycle timer (e.g., drxShortCycleTimer) expires, long DRX Cycle (e.g., long DRX Cycle #n+1 in FIG. 2) starts.
v) If any DCI (PDCCH) arrives during the wake-up period of any DRX cycle, go to step ii).

As a whole, if the Short DRX Cycle is used, and [(SFN×10)+subframe number] modulo (drx-ShortCycle)=(drx-StartOffset) modulo (drx-ShortCycle); or if the Long DRX Cycle is used, and [(SFN×10)+subframe number] modulo (drx-LongCycle)=drx-StartOffset, then, start drx-onDurationTimer after drx-SlotOffset from the beginning of the subframe.

Cell discontinuous transmission (DTX) is introduced to save the power consumption at the network side (e.g., at gNB).

It is preferable to align the cell DTX and UE DRX so that when the network performs transmission, the target UE is in the active time period.

If the cell DTX cycle and the UE DRX cycle are the same or in a multiple relation (e.g., the UE DRX cycle is a multiple of the cell DTX cycle) when the number of UEs in a cell is very small, it is straightforward to align the cell DTX offset and the UE DRX offset (e.g., drx-StartOffset shown in FIG. 3) so that the cell DTX OnDuration period and the UE DRX OnDuration period can be aligned. FIG. 3 illustrates this straightforward solution (the left arrows in ‘UE DRX 1’).

However, if the cell DTX cycle and the UE DRX cycle are not in a multiple relation (‘UE DRX 2’in FIG. 3), it is unclear how to align the cell DTX OnDuration period and the UE DRX OnDuration period. For example, the UE DRX OnDuration periods may be moved leftwards (see the left arrows in ‘UE DRX 2’) or rightwards (see the right arrow in ‘UE DRX 2’) to align with the cell DTX OnDuration period.

In addition, if the UE DRX OnDuration period of each UE is scheduled to be in the same cell DTX OnDuration period, a scheduling collision would probably happen especially for a large number of UEs are in the same cell.

This invention targets the above issues.

### BRIEF SUMMARY

Methods and apparatuses for cell DTX and UE DRX alignment are disclosed.

In one embodiment, a UE comprises a processor; and a transceiver coupled to the processor, wherein the processor is configured to receive, via the transceiver, a UE DRX configuration, and a cell DTX configuration; and determine new UE DRX parameters according to the UE DRX configuration and the cell DTX configuration.

In some embodiment, the UE DRX configuration includes a first UE DRX cycle (T1), the cell DTX configuration includes at least one cell DTX cycle (TA), and the processor is configured to determine a new UE DRX cycle (T1_{new}) in the new UE DRX parameters according to the first UE DRX cycle (T1) and one cell DTX cycle (TA). In some embodiment, the cell DTX configuration includes multiple cell DTX cycles, and the one cell DTX cycle is determined from the multiple cell DTX cycles. In particular, the one cell DTX cycle is determined by higher layer signaling, or the one cell DTX cycle is determined by a type of the one cell DTX cycle being the same as a type of the configured first UE DRX cycle, or the one cell DTX cycle is determined by the configured first UE DRX cycle being a multiple of the one cell DTX cycle.

In some embodiment, the first UE DRX cycle is a first UE long DRX cycle (T1_{long}), and the UE DRX configuration further includes a first UE short DRX cycle (T1ₛₕₒᵣₜ), the new UE DRX cycle is a new UE long DRX cycle (T1_{newlong}), and the processor is configured to determine a new UE short DRX cycle (T1_{newshort}) in the new UE DRX parameters according to the first UE short DRX cycle (T1ₛₕₒᵣₜ) and the one cell DTX cycle (TA). In some embodiment, the processor is configured to determine the new UE long DRX cycle (T1_{newlong}) according to the determined new UE short DRX cycle (T1_{newshort}).

In some embodiment, the cell DTX configuration includes a cell DTX offset, and the processor is configured to determine a new UE DRX offset in the new UE DRX parameters according to at least one of the cell DTX offset and an additional offset. In some embodiment, the additional offset is configured by higher layer signaling, or determined by the first UE DRX offset and a threshold, or determined by UE ID related information. In particular, the additional offset is one or more of the cell DTX cycle, or one or more of DRX cycle OnDuration period configured in the UE DRX configuration.

In some embodiment, the processor is further configured to use an active time for data reception based on the new UE DRX parameters.

In one embodiment, a method at a UE comprises receiving a UE DRX configuration and a cell DTX configuration; and determining new UE DRX parameters according to the UE DRX configuration and the cell DTX configuration.

In another embodiment, a base unit comprises a processor; and a transceiver coupled to the processor, wherein the processor is configured to transmit, via the transceiver, a UE DRX configuration, and a cell DTX configuration; and determine new UE DRX parameters according to the UE DRX configuration and the cell DTX configuration.

In yet another embodiment, a method at a base unit comprises transmitting a UE DRX configuration and a cell DTX configuration; and determining new UE DRX parameters according to the UE DRX configuration and the cell DTX configuration.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a principle of DRX mechanism;

FIG. 2 illustrates a principle of C-DRX;

FIG. 3 illustrates the problems in the prior art;

FIG. 4 illustrates a first example of the first sub-embodiment of the first embodiment;

FIG. 5 illustrates an example of the first sub-embodiment of the second embodiment;

FIG. 6 illustrates an example of the first example of the first sub-embodiment and the first sub-embodiment of the second embodiment;

FIG. 7 illustrates a third example of the second sub-embodiment of the second embodiment;

FIG. 8 is a schematic flow chart diagram illustrating an embodiment of a method;

FIG. 9 is a schematic flow chart diagram illustrating another embodiment of a method; and

FIG. 10 is a schematic block diagram illustrating apparatuses according to one embodiment.

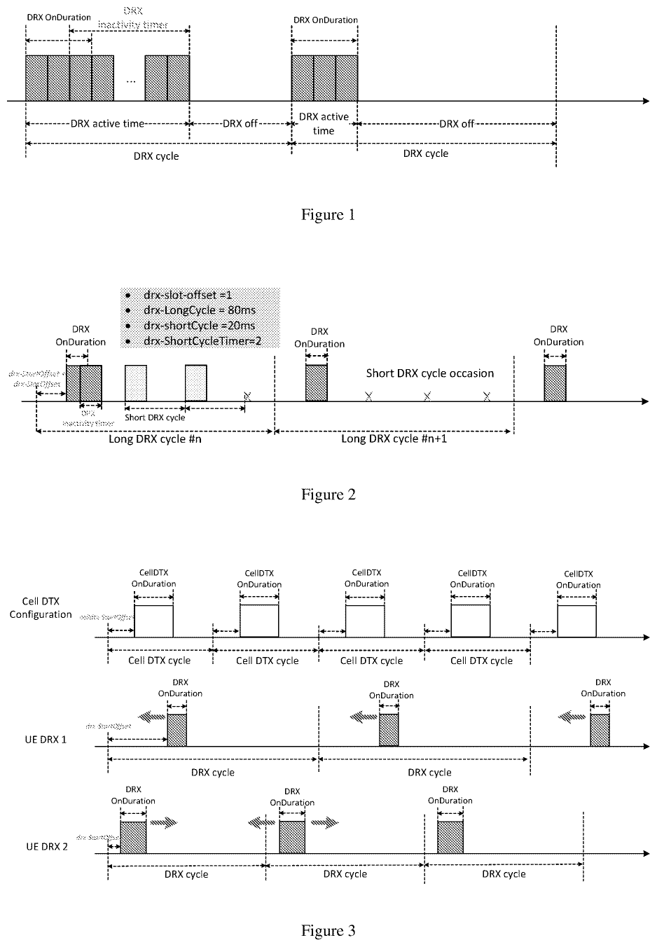

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

There are two types of UE DRX cycle. A first type is a multiple of 10 ms. It means that the UE DRX cycle (e.g., UE long DRX cycle or UE short DRX cycle) can be 10 ms, 20 ms, 40 ms, 60 ms, 70 ms, 80 ms, 160 ms, 320 ms, 640 ms, 1280 ms, 2560 ms, 5120 ms, 10240 ms, etc. A second type is 2^{m} ms, where m is an integer. It means that the UE DRX cycle (e.g., UE long DRX cycle or UE short DRX cycle) can be 32 (=2⁵ ) ms, 64 (=2⁶ ) ms, 128 (=2⁷ ) ms, 256 (=2⁸ ) ms, 512 (=2⁹ ) ms, 1024 (=2¹⁰) ms, 2048 (=2¹¹ ) ms, etc.

UE is configured with UE DRX configuration, where the UE DRX configuration includes UE DRX cycle (T1) (e.g., UE long DRX cycle (T1_{long})), and optionally includes UE short DRX cycle (T1ₛₕₒᵣₜ). The UE DRX configuration also includes DRX OnDuration period, and UE DRX offset (t1) which indicates the start of the DRX OnDuration period from the start of the UE DRX cycle (e.g., UE long DRX cycle). The UE DRX offset (t1) is indicated by the higher layer parameter drx-StartOffset and another higher layer parameter drx-SlotOffset. The higher layer parameter drx-StartOffset indicates a value that is in unit of millisecond (ms), while the higher layer parameter drx-SlotOffset indicates a value that is in unit of 1/32 ms (e.g., value 0 corresponds to 0 ms, value 1 corresponds to 1/32 ms, value 2 corresponds to 2/32 ms, and so on). So, the UE DRX offset (t1) is equal to drx-StartOffset plus drx-SlotOffset.

UE is further configured with cell DTX configuration, e.g., by broadcast signaling or by UE-specific RRC signaling, where the cell DTX configuration may include one or multiple cell DTX cycles.

In consideration of two types of UE DRX cycle, the cell DTX configuration may include two cell DTX cycles (e.g., TA and TB), where one cell DTX cycle is a multiple of 10 ms, and the other cell DTX cycle is 2^{m} ms, where m is an integer. Each cell DTX cycle is associated with a cell DTX offset (e.g., tA and tB), which indicates the offset of the cell DTX OnDuration period from the start of the cell DTX cycle. Similar to the UE DRX offset, the cell DTX offset can be indicated by a higher layer parameter celldtx-StartOffset, or indicated by the higher layer parameter celldtx-StartOffset and another higher layer parameter celldtx-SlotOffset. The higher layer parameter celldtx-StartOffset indicates a value that is in unit of millisecond (ms), while the higher layer parameter celldtx-SlotOffset indicates a value that is in unit of 1/32 ms.

In order to facilitate the gNB dynamic configuration, UE can be optionally indicated via a control signal to scale up the cell DTX cycle configured by higher layer or to select a specific cell DTX cycle (e.g., when more than one cell DTX cycle is configured).

For example, if the cell DRX cycle configured by RRC signaling or broadcast signaling is 40 ms, the cell DRX cycle can be updated by a control signal indicating a scaling factor to 80 ms, or 160 ms.

According to this disclosure, new UE DRX parameters are determined in consideration of the configured cell DTX configuration and the configured UE DRX configuration. Accordingly, the new UE DRX parameters can be referred to as cell DTX associated UE DRX parameters, or UE DRX parameters associated with cell DTX configuration.

The new UE DRX parameters include new UE DRX cycle (T1_{new}) and new UE DRX offset. In consideration of the UE DRX cycle (T1) may include both UE long DRX cycle (T1_{long}) and UE short DRX cycle (T1ₛₕₒᵣₜ), the new UE DRX cycle (T1_{new}) may also include new UE long DRX cycle (T1_{newlong}) and new UE short DRX cycle (T1_{newshort}). In particular, if the configured UE DRX configuration only includes UE DRX cycle (e.g., UE long DRX cycle), the new UE DRX parameters only include new UE DRX cycle (e.g., new UE long DRX cycle), while if the configured UE DRX configuration includes both UE long DRX cycle and UE short DRX cycle, the new UE DRX parameters include both new UE long DRX cycle and new UE short DRX cycle.

A first embodiment relates to determining the new UE DRX cycle (T1_{new}). The new UE DRX cycle (T1_{new}) is determined by the configured UE DRX cycle (T1) and one configured cell DTX cycle (TA).

First, if the cell DTX configuration includes more than one cell DTX cycle, e.g., two cell DTX cycles, the UE chooses one cell DTX cycle (TA) according to the configured UE DRX cycle (T1).

For example, if the cell DTX configuration includes two cell DTX cycles in two types, the UE chooses one cell DTX cycle that has the same type as the configured UE DRX cycle (e.g., UE long DRX cycle). It means that if the configured UE DRX cycle (e.g., UE long DRX cycle) is a multiple of 10 ms, the cell DTX cycle that is a multiple of 10 ms is chosen, while if the UE DRX cycle (e.g., UE long DRX cycle) is a 2^{m} ms, where m is an integer, the cell DTX cycle that is a 2^{m} ms, where m is an integer, is chosen. From another point of view, one cell DTX cycle is chosen if the UE DRX cycle is one or multiple of the one cell DTX cycle. In other words, if the UE DRX cycle is divided by one cell DTX cycle so that the remainder is 0, the one cell DTX cycle is chosen. For example, if the cell DTX configuration includes two cell DTX cycles in which one cell DTX cycle is 40 ms and the other cell DTX cycle is 64 ms, and the UE DRX cycle (e.g., UE long DRX cycle) is 80 ms, then the cell DTX cycle of 40 ms is chosen as the one cell DTX cycle, because both 40 ms and 80 ms are a multiple of 10 ms, or because 80 ms is two times of 40 ms, or because 80/40=2 with remainder being 0. From another point of view, the cell DTX cycle of 64 ms is not chosen because 64 ms is a type of 2^{m} while 80 ms is not a type of 2^{m} (80 ms is a different type of a multiple of 10 ms), or because 80 ms is not a multiple of 64 ms, or because 80/64=1 with remainder being 16 which is not 0. Incidentally, the one cell DTX cycle to be chosen can be configured by a higher layer signaling.

If the cell DTX configuration includes only one cell DTX cycle, the one cell DTX cycle is chosen automatically.

In the following description, it is assumed that the chosen cell DTX cycle is TA, and the configured UE DRX cycle (e.g., UE long DRX cycle) is T1.

According to a first sub-embodiment of the first embodiment, the new UE DRX cycle (T1_{new}) (e.g., new UE long DRX cycle (T1_{newlong})) is determined as ceil(T1/TA)*TA or floor (T1/TA)*TA, where ceil(x) means the smallest integer that is equal to or larger than x, while floor(x) the largest integer that is equal to or smaller than x.

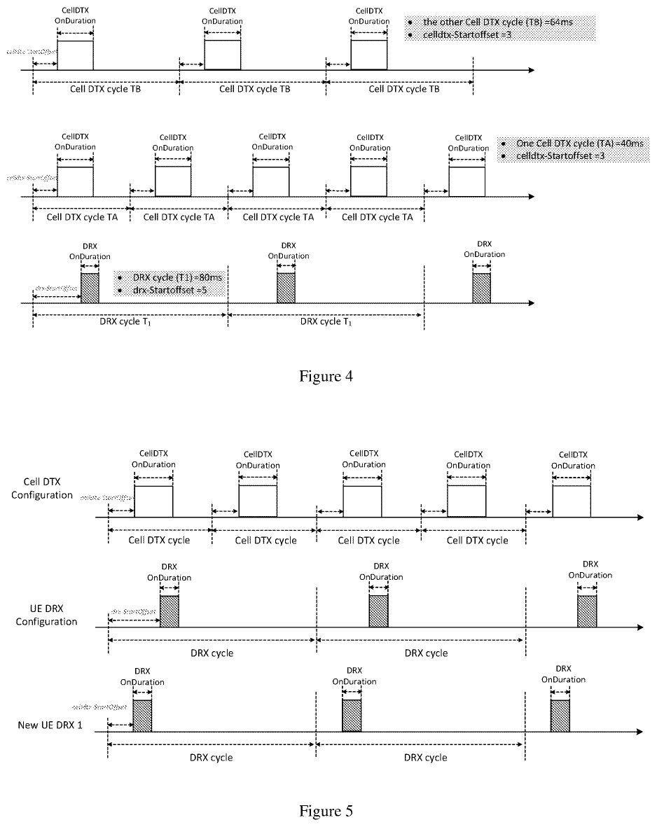

FIG. 4 illustrates a first example of the first sub-embodiment, in which the cell DTX configuration includes two cell DTX cycles in which one cell DTX cycle is 40 ms and the other cell DTX cycle is 64 ms, and the configured UE DRX cycle (e.g., UE long DRX cycle) is 80 ms. As described above, the chosen cell DTX cycle (TA) is 40 ms, and T1=80 ms. So, the new UE DRX cycle (T1_{new}) is ceil(T1/TA)*TA =ceil(80/40)*40=80 ms.

In a second example of the first sub-embodiment, the cell DTX configuration includes one cell DTX cycle of 64 ms (i.e., TA=64 ms), and T1=80 ms. So, the new UE DRX cycle is ceil(T1/TA)*TA=ceil(80/64)*64=128 ms.

In a second sub-embodiment of the first embodiment, it is assumed that the configured UE DRX cycle includes UE long DRX cycle (T1_{long}) and UE short DRX cycle (T1ₛₕₒᵣₜ). According to the second sub-embodiment of the first embodiment, the new UE short DRX cycle (T1_{newshort}) can be determined as ceil(T1ₛₕₒᵣₜ/TA)*TA or floor (T1ₛₕₒᵣₜ/TA)*TA, and the new UE long DRX cycle (T1_{newlong}) can be determined as ceil(T1_{long}/TA)*TA or floor (T1_{long}/TA)*TA. Alternatively, to maintain the multiple relations between the new UE long DRX cycle and the new UE short DRX cycle, the new UE long DRX cycle (T1_{newlong}) can be determined as ceil(T1ₛₕₒᵣₜ/TA)*TA*T1_{long}/T1ₛₕₒᵣₜ or floor (T1ₛₕₒᵣₜ/TA)*TA*T1_{long}/T1ₛₕₒᵣₜ=T1_{newshort}*T1_{long/T}1ₛₕₒᵣₜ. For example, the chosen cell DTX cycle (TA) is 32 ms, and the UE short DRX cycle (T1ₛₕₒᵣₜ) is 80 ms and the UE long DRX cycle (T1_{long}) is 160 ms. So, the new UE short DRX cycle (T1_{newshort}) is ceil(T1ₛₕₒᵣₜ/TA)*TA=ceil(80/32)*32=96 ms, and the new UE long DRX cycle (T1_{newlong}) is new UE short DRX cycle*T1_{long}/T1ₛₕₒᵣₜ=96*160/80=192 ms.

In a third sub-embodiment of the first embodiment, it is also assumed that the configured UE DRX cycle includes UE long DRX cycle (T1_{long}) and UE short DRX cycle (T1ₛₕₒᵣₜ). According to the third sub-embodiment of the first embodiment, the new UE short DRX cycle (T1_{newshort}) is equal to K*TA, where, K is the maximal value that meets K*TA<T1ₛₕₒᵣₜ or K is the minimal value that meets K*TA>T1ₛₕₒᵣₜ, and the new UE long DRX cycle (T1_{newlong}) is equal to G*K*TA, where, G is the maximal value that meets G*K*TA<T1_{long} or G is the minimal value that meets G*K*TA>T1_{long}. For example, the chosen cell DTX cycle (TA) is 32 ms, and the UE short DRX cycle (T1ₛₕₒᵣₜ) is 80 ms and the UE long DRX cycle (T1_{long}) is 640 ms. The new UE short DRX cycle is 3*32=96, where K (=3) is the minimal value that meets K*TA>T1ₛₕₒᵣₜ (3*32>80); and the new UE long DRX cycle is 7*3*32=672 ms, where G (=7) is the minimal value that meets G*K*TA>T1_{long} (7*3*32>640).

In the second sub-embodiment and the third sub-embodiment of the first embodiment, the new UE short DRX cycle (T1_{newshort}) is determined according to the configured UE short DRX cycle (T1ₛₕₒᵣₜ) and the configured cell DTX cycle (TA). The new UE long DRX cycle (T1_{newlong}) is determined according to the configured UE long DRX cycle (T1_{long}) and the configured cell DTX cycle (TA), or determined by the new UE short DRX cycle (T1_{newshort}).

It can be seen from FIG. 4 that although the new UE DRX cycle is determined, the DRX OnDuration period is not aligned with the cell DTX OnDuration period because the UE DRX offset (e.g., drx-StartOffset, which is 5 ms in FIG. 4, while drx-SlotOffset is not shown in FIG. 4 and can be regarded as being equal to 0) is different from the cell DTX offset (e.g., celldtx-StartOffset, which is 3 ms in FIG. 4).

A second embodiment relates to determining new UE DRX offset.

According to a first sub-embodiment of the second embodiment, the new UE DRX offset is determined by the configured cell DTX offset (e.g., the cell DTX offset for the chosen cell DTX cycle). The cell DTX offset can be a value in unit of subframe (i.e., in unit of ms) determined by the higher layer parameter celldtx-StartOffset or can be a value in unit of subframe (i.e., in unit of ms) determined by the higher layer parameter celldtx-StartOffset plus a value in unit of 1/32 ms determined by the higher layer parameter celldtx-SlotOffset. The new UE DRX offset being determined by the configured cell DTX offset means that, if the cell DTX offset is a value determined only by the higher layer signaling celldtx-StartOffset (Situation 1), the new UE DRX offset is equal to celldtx-StartOffset (Alternative 1 in Situation 1) or equal to celldtx-StartOffset plus configured drx-SlotOffset (Alternative 2 in Situation 1), while, if the cell DTX offset is a value in unit of subframe determined by the higher layer parameter celldtx-StartOffset plus a value in unit of 1/32 ms determined by the higher layer parameter celldtx-SlotOffset (Situation 2), the cell DTX offset is equal to celldtx-StartOffset (Alternative 1 in Situation 2) or equal to celldtx-StartOffset plus celldtx-SlotOffset (Alternative 2 in Situation 2) or equal to celldtx-StartOffset plus configured drx-SlotOffset (Alternative 3 in Situation 2). It can be seen that the ‘StartOffset’ part of the new UE DRX offset is always determined as the configured celldtx-StartOffset. On the other hand, the ‘SlotOffset’ part of the new UE DRX offset may not always be determined as the configured celldtx-SlotOffset even celldtx-SlotOffset is configured. It means that if celldtx-SlotOffset is not configured, the ‘SlotOffset’ part of the new UE DRX offset may be determined as 0 (i.e., Alternative 1 in Situation 1) or as the configured drx-SlotOffset (Alternative 2 in Situation 1). In addition, even if celldtx-SlotOffset is configured, the ‘SlotOffset’ part of the new UE DRX offset may, in addition to being determined as the configured celldtx-SlotOffset (Alternative 2 in Situation 2), be determined as 0 (Alternative 1 in Situation 2) or as the configured drx-SlotOffset (Alternative 2 in Situation 3).

FIG. 5 illustrates an example of the first sub-embodiment of the second embodiment. The new UE DRX offset is determined by the configured cell DTX offset (celldtx-StartOffset in FIG. 5), so that the DRX OnDuration period of the new UE DRX 1 is aligned with the cell DTX OnDuration period of the cell DTX configuration.

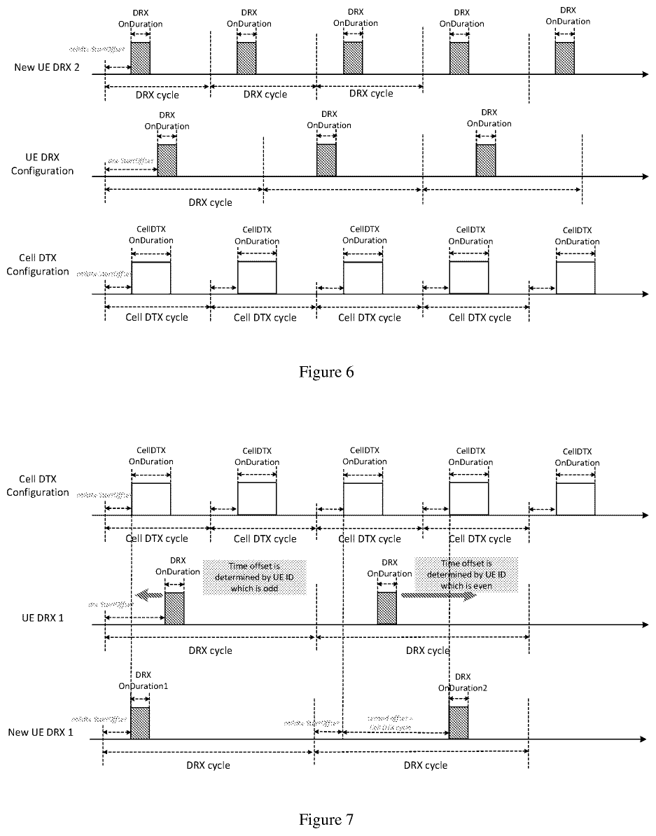

FIG. 6 illustrates an example of the first example of the first sub-embodiment and the first sub-embodiment of the second embodiment. The new DRX cycle (of new UE DRX 2) is determined as being equal to the cell DTX cycle. In addition, the new UE DRX offset of new UE DRX 2 is determined by the cell DTX offset (celldtx-StartOffset in FIG. 6).

If the new UE DRX offset is equal to the cell DTX offset, and the new UE DRX cycle is equal to one or multiple of the cell DTX cycle, then it is definite that the DRX OnDuration period (based on the new UE DRX parameters) is aligned with the cell DTX OnDuration period.

However, if the cell serves many UEs, if the new UE DRX offset is determined only by the cell DTX offset, the DRX OnDuration period (based on the new UE DRX parameters) of each UE served in the cell will be in the same position that is aligned with the same cell DTX OnDuration period. If the new UE DRX cycle is M times of the cell DTX cycle (e.g., M=G*K according to the third sub-embodiment of the first embodiment), it is preferable to distribute the DRX OnDuration period of each UE among the M cell DTX OnDuration periods. Further, if the cell DTX OnDuration period is much longer than the UE DRX OnDuration period, it is also possible that the UE DRX OnDuration period of each UE is distributed in different positions within the same cell DTX OnDuration period.

According to a second sub-embodiment of the second embodiment, the new UE DRX offset is determined by the cell DTX offset (e.g., the cell DTX offset for the chosen cell DTX cycle) and a second offset, wherein the second offset can be configured by higher layer signaling, or determined by the UE DRX offset and a threshold, or determined by UE ID related information.

In a first example, if the configured UE DRX offset <cell DTX cycle/2, the second offset=0; otherwise (the configured UE DRX offset>=cell DTX cycle/2), the second offset is one cell DTX cycle.

In a second example, if abs(the configured UE DRX offset-cell DTX offset)<a threshold, the second offset=0; otherwise (abs(the configured UE DRX offset-cell DTX offset)>=the threshold), the second offset is one UE DRX OnDuration period.

In a third example, if UE ID is odd, the second offset=0; otherwise (UE ID is even), the second offset is one cell DTX cycle.

FIG. 7 illustrates the third example. If UE ID is odd, the new UE DRX offset is determined by the cell DTX offset and the second offset which is 0. It means that the new UE DRX offset is equal to the cell DTX offset (e.g., celldtx-StartOffset). That is, the DRX OnDuration period is moved leftward to the position that is celldtx-StartOffset from the start of the DRX cycle (see ‘New UE DRX 1’, ‘DRX OnDuration1’). On the other hand, if UE ID is not odd (e.g., is even), the new UE DRX offset is determined by the cell DTX offset and the second offset which is one cell DTX cycle. It means that the new UE DRX offset is equal to the cell DTX offset (celldtx-StartOffset) plus one cell DTX cycle. That is, the DRX OnDuration period is moved rightward to the position that is celldtx-StartOffset+cell DTX cycle from the start of the DRX cycle (see ‘New UE DRX 1’, ‘DRX OnDuration2’).

In a fourth example, if UE ID is odd, the second offset=0; otherwise (UE ID is even), the second offset is one UE DRX OnDuration period.

As a whole, according to this disclosure, if the Short DRX Cycle associated with cell DTX configuration is used, and [(SFN×10)+subframe number] modulo (celldtx-drx-ShortCycle)=(celldtx-drx-StartOffset) modulo (celldtx-drx-ShortCycle); or if Long DRX Cycle associated with cell DTX configuration is used, and [(SFN×10)+subframe number] modulo (celldtx-drx-LongCycle)=celldtx-drx-StartOffset, then, start drx-onDurationTimer after drx-SlotOffset from the beginning of the subframe.

That is, the UE uses an active time for data reception based on the new UE DRX parameters. Correspondingly, the base unit (e.g., gNB) uses an active time for data transmission based on the new UE DRX parameters.

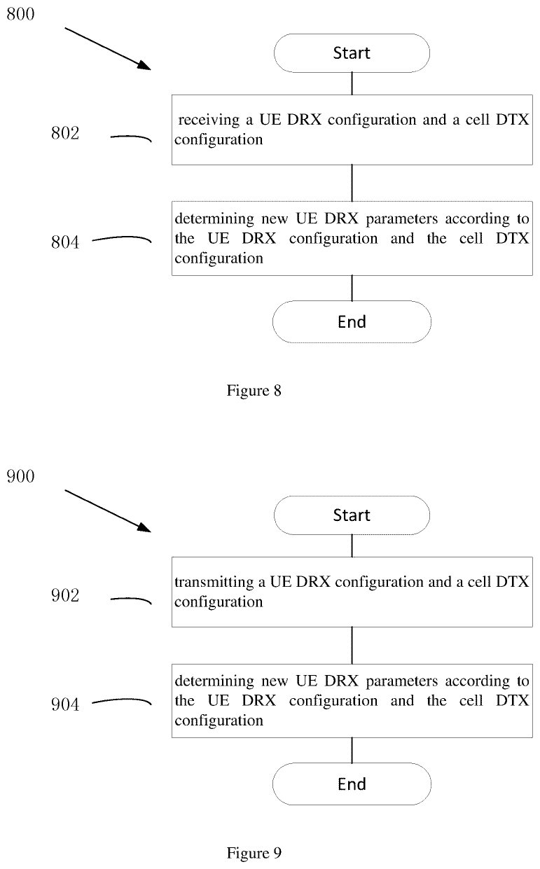

FIG. 8 is a schematic flow chart diagram illustrating an embodiment of a method 800 according to the present application. In some embodiments, the method 800 is performed by an apparatus, such as a remote unit (UE). In certain embodiments, the method 800 may be performed by a processor executing program code, for example, a microcontroller, a microprocessor, a CPU, a GPU, an auxiliary processing unit, a FPGA, or the like.

The method 800 may comprise 802 receiving a UE DRX configuration and a cell DTX configuration; and 804 determining new UE DRX parameters according to the UE DRX configuration and the cell DTX configuration.

In some embodiment, the UE DRX configuration includes a first UE DRX cycle (T1), the cell DTX configuration includes at least one cell DTX cycle (TA), and the method comprises determining a new UE DRX cycle (T1_{new}) in the new UE DRX parameters according to the first UE DRX cycle (T1) and one cell DTX cycle (TA). In some embodiment, the cell DTX configuration includes multiple cell DTX cycles, and the one cell DTX cycle is determined from the multiple cell DTX cycles. In particular, the one cell DTX cycle is determined by higher layer signaling, or the one cell DTX cycle is determined by a type of the one cell DTX cycle being the same as a type of the configured first UE DRX cycle, or the one cell DTX cycle is determined by the configured first UE DRX cycle being a multiple of the one cell DTX cycle.

In some embodiment, the first UE DRX cycle is a first UE long DRX cycle (T1_{long}), and the UE DRX configuration further includes a first UE short DRX cycle (T1ₛₕₒᵣₜ), the new UE DRX cycle is a new UE long DRX cycle (T1_{newlong}), and the method comprises determining a new UE short DRX cycle (T1_{newshort}) in the new UE DRX parameters according to the first UE short DRX cycle (T1ₛₕₒᵣₜ) and the one cell DTX cycle (TA). In some embodiment, the method comprises determining the new UE long DRX cycle (T1_{newlong}) according to the determined new UE short DRX cycle (T1_{newshort}).

In some embodiment, the cell DTX configuration includes a cell DTX offset, the method comprises determining a new UE DRX offset in the new UE DRX parameters according to at least one of the cell DTX offset and an additional offset. In some embodiment, the additional offset is configured by higher layer signaling, or determined by the first UE DRX offset and a threshold, or determined by UE ID related information. In particular, the additional offset is one or more of the cell DTX cycle, or one or more of DRX cycle OnDuration period configured in the UE DRX configuration.

In some embodiment, the method further comprises using an active time for data reception based on the new UE DRX parameters.

FIG. 9 is a schematic flow chart diagram illustrating a further embodiment of a method 900 according to the present application. In some embodiments, the method 900 is performed by an apparatus, such as a base unit. In certain embodiments, the method 900 may be performed by a processor executing program code, for example, a microcontroller, a microprocessor, a CPU, a GPU, an auxiliary processing unit, a FPGA, or the like.

The method 900 may comprise 902 transmitting a UE DRX configuration and a cell DTX configuration; and 904 determining new UE DRX parameters according to the UE DRX configuration and the cell DTX configuration.

In some embodiment, the UE DRX configuration includes a first UE DRX cycle (T1), the cell DTX configuration includes at least one cell DTX cycle (TA), and the method comprises determining a new UE DRX cycle (T1_{new}) in the new UE DRX parameters according to the first UE DRX cycle (T1) and one cell DTX cycle (TA). In some embodiment, the cell DTX configuration includes multiple cell DTX cycles, and the one cell DTX cycle is determined from the multiple cell DTX cycles. In particular, the one cell DTX cycle is determined by higher layer signaling, or the one cell DTX cycle is determined by a type of the one cell DTX cycle being the same as a type of the configured first UE DRX cycle, or the one cell DTX cycle is determined by the configured first UE DRX cycle being a multiple of the one cell DTX cycle.

In some embodiment, the first UE DRX cycle is a first UE long DRX cycle (T1_{long}), and the UE DRX configuration further includes a first UE short DRX cycle (T1ₛₕₒᵣₜ), the new UE DRX cycle is a new UE long DRX cycle (T1_{newlong}), and the method comprises determining a new UE short DRX cycle (T1_{newshort}) in the new UE DRX parameters according to the first UE short DRX cycle (T1ₛₕₒᵣₜ) and the one cell DTX cycle (TA). In some embodiment, the method comprises determining the new UE long DRX cycle (T1_{newlong}) according to the determined new UE short DRX cycle (T1_{newshort}).

In some embodiment, the cell DTX configuration includes a cell DTX offset, the method comprises determining a new UE DRX offset in the new UE DRX parameters according to at least one of the cell DTX offset and an additional offset. In some embodiment, the additional offset is configured by higher layer signaling, or determined by the first UE DRX offset and a threshold, or determined by UE ID related information. In particular, the additional offset is one or more of the cell DTX cycle, or one or more of DRX cycle OnDuration period configured in the UE DRX configuration.

In some embodiment, the method further comprises using an active time for data transmission based on the new UE DRX parameters.

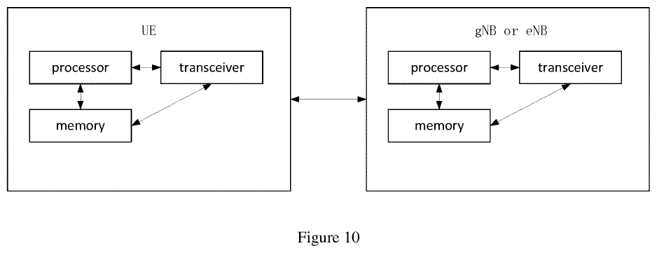

FIG. 10 is a schematic block diagram illustrating apparatuses according to one embodiment.

Referring to FIG. 10, the UE (i.e., the remote unit) includes a processor, a memory, and a transceiver. The processor implements a function, a process, and/or a method which are proposed in FIG. 8.

The UE comprises a processor; and a transceiver coupled to the processor, wherein the processor is configured to receive, via the transceiver, a UE DRX configuration, and a cell DTX configuration; and determine new UE DRX parameters according to the UE DRX configuration and the cell DTX configuration.

In some embodiment, the UE DRX configuration includes a first UE DRX cycle (T1), the cell DTX configuration includes at least one cell DTX cycle (TA), and the processor is configured to determine a new UE DRX cycle (T1_{new}) in the new UE DRX parameters according to the first UE DRX cycle (T1) and one cell DTX cycle (TA). In some embodiment, the cell DTX configuration includes multiple cell DTX cycles, and the one cell DTX cycle is determined from the multiple cell DTX cycles. In particular, the one cell DTX cycle is determined by higher layer signaling, or the one cell DTX cycle is determined by a type of the one cell DTX cycle being the same as a type of the configured first UE DRX cycle, or the one cell DTX cycle is determined by the configured first UE DRX cycle being a multiple of the one cell DTX cycle.

In some embodiment, the first UE DRX cycle is a first UE long DRX cycle (T1_{long}), and the UE DRX configuration further includes a first UE short DRX cycle (T1ₛₕₒᵣₜ), the new UE DRX cycle is a new UE long DRX cycle (T1_{newlong}), and the processor is configured to determine a new UE short DRX cycle (T1_{newshort}) in the new UE DRX parameters according to the first UE short DRX cycle (T1ₛₕₒᵣₜ) and the one cell DTX cycle (TA). In some embodiment, the processor is configured to determine the new UE long DRX cycle (T1_{newlong}) according to the determined new UE short DRX cycle (T1_{newshort}).

In some embodiment, the cell DTX configuration includes a cell DTX offset, and the processor is configured to determine a new UE DRX offset in the new UE DRX parameters according to at least one of the cell DTX offset and an additional offset. In some embodiment, the additional offset is configured by higher layer signaling, or determined by the first UE DRX offset and a threshold, or determined by UE ID related information. In particular, the additional offset is one or more of the cell DTX cycle, or one or more of DRX cycle OnDuration period configured in the UE DRX configuration.

In some embodiment, the processor is further configured to use an active time for data reception based on the new UE DRX parameters.

Referring to FIG. 10, the gNB (i.e., base unit) includes a processor, a memory, and a transceiver. The processors implement a function, a process, and/or a method which are proposed in FIG. 9.

The base unit comprises a processor; and a transceiver coupled to the processor, wherein the processor is configured to transmit, via the transceiver, a UE DRX configuration, and a cell DTX configuration; and determine new UE DRX parameters according to the UE DRX configuration and the cell DTX configuration.

In some embodiment, the UE DRX configuration includes a first UE DRX cycle (T1), the cell DTX configuration includes at least one cell DTX cycle (TA), and the processor is configured to determine a new UE DRX cycle (T1_{new}) in the new UE DRX parameters according to the first UE DRX cycle (T1) and one cell DTX cycle (TA). In some embodiment, the cell DTX configuration includes multiple cell DTX cycles, and the one cell DTX cycle is determined from the multiple cell DTX cycles. In particular, the one cell DTX cycle is determined by higher layer signaling, or the one cell DTX cycle is determined by a type of the one cell DTX cycle being the same as a type of the configured first UE DRX cycle, or the one cell DTX cycle is determined by the configured first UE DRX cycle being a multiple of the one cell DTX cycle.

In some embodiment, the first UE DRX cycle is a first UE long DRX cycle (T1_{long}), and the UE DRX configuration further includes a first UE short DRX cycle (T1ₛₕₒᵣₜ), the new UE DRX cycle is a new UE long DRX cycle (T1_{newlong}), and the processor is configured to determine a new UE short DRX cycle (T1_{newshort}) in the new UE DRX parameters according to the first UE short DRX cycle (T1ₛₕₒᵣₜ) and the one cell DTX cycle (TA). In some embodiment, the processor is configured to determine the new UE long DRX cycle (T1_{newlong}) according to the determined new UE short DRX cycle (T1_{newshort}).

In some embodiment, the cell DTX configuration includes a cell DTX offset, and the processor is configured to determine a new UE DRX offset in the new UE DRX parameters according to at least one of the cell DTX offset and an additional offset. In some embodiment, the additional offset is configured by higher layer signaling, or determined by the first UE DRX offset and a threshold, or determined by UE ID related information. In particular, the additional offset is one or more of the cell DTX cycle, or one or more of DRX cycle OnDuration period configured in the UE DRX configuration.

In some embodiment, the processor is further configured to use an active time for data transmission based on the new UE DRX parameters.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1-15. (canceled)

16. A user equipment (UE) for wireless communication, comprising:
at least one memory; and
at least one processor coupled with the at least one memory and operable to cause the UE to:
receive a UE discontinuous reception (DRX) configuration and a cell discontinuous transmission (DTX) configuration; and
determine one or more UE DRX parameters according to the UE DRX configuration and the cell DTX configuration.

17. The UE of claim 16, wherein:
the UE DRX configuration includes a first UE DRX cycle;
the cell DTX configuration includes at least one cell DTX cycle; and
the at least one processor is operable to cause the UE to determine a second UE DRX cycle in the one or more UE DRX parameters according to the first UE DRX cycle and the at least one cell DTX cycle.

18. The UE of claim 17, wherein the cell DTX configuration includes multiple cell DTX cycles, and the at least one cell DTX cycle is determined from the multiple cell DTX cycles.

19. The UE of claim 18, wherein:
the at least one cell DTX cycle is determined by higher layer signaling;
the at least one cell DTX cycle is determined by a type of the at least one cell DTX cycle being the same as a type of the first UE DRX cycle; or
the at least one cell DTX cycle is determined by the first UE DRX cycle being a multiple of the at least one cell DTX cycle.

20. The UE of claim 17, wherein:
the first UE DRX cycle comprises a first UE long DRX cycle, and the UE DRX configuration further includes a first UE short DRX cycle;
the first UE DRX cycle comprises a second UE long DRX cycle; and
the at least one processor is operable to cause the UE to determine a second UE short DRX cycle in the one or more UE DRX parameters according to the first UE short DRX cycle and the at least one cell DTX cycle.

21. The UE of claim 20, wherein, the at least one processor is operable to cause the UE to determine the second UE long DRX cycle based at least in part on the second UE short DRX cycle.

22. The UE of claim 16, wherein the cell DTX configuration includes a cell DTX offset, and the at least one processor is operable to cause the UE to determine a first UE DRX offset in the one or more UE DRX parameters according to at least one of the cell DTX offset or an additional offset.

23. The UE of claim 22, wherein the additional offset is configured by higher layer signaling, determined by the first UE DRX offset and a threshold, or determined by UE identifier (ID) related information.

24. The UE of claim 23, wherein the additional offset is one or more of at least one cell DTX cycle or a DRX cycle OnDuration period configured in the UE DRX configuration.

25. The UE of claim 16, wherein the at least one processor is further operable to cause the UE to use an active time for data reception based on the one or more UE DRX parameters.

26. A method performed by a user equipment (UE), the method comprising:
receiving a UE discontinuous reception (DRX) configuration and a cell discontinuous transmission (DTX) configuration; and
determining one or more UE DRX parameters according to the UE DRX configuration and the cell DTX configuration.

27. The method of claim 26, wherein:
the UE DRX configuration includes a first UE DRX cycle;
the cell DTX configuration includes at least one cell DTX cycle; and
the method further comprises determining a second UE DRX cycle in the one or more UE DRX parameters according to the first UE DRX cycle and the at least one cell DTX cycle.

28. The method of claim 27, wherein:
the first UE DRX cycle comprises a first UE long DRX cycle, and the UE DRX configuration further includes a first UE short DRX cycle;
the first UE DRX cycle comprises a second UE long DRX cycle; and
the method further comprises determining a second UE short DRX cycle in the one or more UE DRX parameters according to the first UE short DRX cycle and the at least one cell DTX cycle.

29. The method of claim 26, wherein the cell DTX configuration includes a cell DTX offset, and the method further comprises determining a first UE DRX offset in the one or more UE DRX parameters according to at least one of the cell DTX offset or an additional offset.

30. The method of claim 29, wherein the additional offset is configured by higher layer signaling, determined by the first UE DRX offset and a threshold, or determined by UE identifier (ID) related information.

31. A base unit, comprising:
at least one memory; and
at least one processor coupled with the at least one memory and operable to cause the base unit to:
transmit a user equipment (UE) discontinuous reception (DRX) configuration and a cell discontinuous transmission (DTX) configuration; and
determine one or more UE DRX parameters according to the UE DRX configuration and the cell DTX configuration.

32. The base unit of claim 31, wherein:
the UE DRX configuration includes a first UE DRX cycle;
the cell DTX configuration includes at least one cell DTX cycle; and
the at least one processor is operable to cause the base unit to determine a second UE DRX cycle in the one or more UE DRX parameters according to the first UE DRX cycle and the at least one cell DTX cycle.

33. The base unit of claim 32, wherein:
the first UE DRX cycle comprises a first UE long DRX cycle, and the UE DRX configuration further includes a first UE short DRX cycle;
the first UE DRX cycle comprises a second UE long DRX cycle; and
the at least one processor is operable to cause the base unit to determine a second UE short DRX cycle in the one or more UE DRX parameters according to the first UE short DRX cycle and the at least one cell DTX cycle.

34. The base unit of claim 31, wherein the cell DTX configuration includes a cell DTX offset, and the at least one processor is operable to cause the base unit to determine a first UE DRX offset in the one or more UE DRX parameters according to at least one of the cell DTX offset or an additional offset.

35. A method performed by a base unit, the method comprising:
transmitting a user equipment (UE) discontinuous reception (DRX) configuration and a cell discontinuous transmission (DTX) configuration; and
determining one or more UE DRX parameters according to the UE DRX configuration and the cell DTX configuration.
